(19) United States
(12) Patent Application Publication
(10) Pub. No.: US 2006/0224404 A1
(43) Pub. Date: Oct. 5, 2006

(54) Web-based system and method for screening job candidates

(76) Inventor: Carl Keusseyan, Houston, TX (US)

Correspondence Address: D'AMBROSIO & ASSOCIATES, P.L.L.C., 10260 WESTHEIMER, SUITE 465, HOUSTON, TX, 77042, US

(21) Appl. No.: 11/099,034

(22) Filed: Apr. 5, 2005

(51) Int. Cl. G06Q 99/00

(52) U.S. Cl. 705/1

(57) ABSTRACT

A web-based system and method for screening job candidates comprising designing a website having essential screening components for one or more specific job openings. The screening components comprise a list of one or more job candidates who have been pre-qualified for a specific job opening according to designated screening components. One of the essential screening components listed on the web site is a video interview of the prescreened job candidate in combination with a resume and test results, if any, for the listed job candidate. The screening components further comprise background checks, credit checks, personality tests, skills tests, and drug tests. The results of administering the screening components are hyperlinked to the web page comprising the list of candidates. Accessibility to the web site is limited to authorized users.

### FIELD OF THE INVENTION

The present invention relates to systems and methods for screening candidates for employment. More specifically, the systems and methods for screening candidates for employment are web based.

### BACKGROUND OF THE INVENTION

Hiring employees is time consuming and costly. This is especially true within large companies for several reasons. Multiple personnel are often involved in the hiring process. Large companies have human resource departments that are responsible for staffing, with or without an outside recruiting firm. Human Resource (H.R.) staff may do the initial screening but, depending on the level of the position to be filled, one or more hiring managers and possibly an executive of the company may be required to be part of the interview process. The interviewing process can extend for several months and may require traveling expenses for candidates or hiring personnel.

In one known method and system for Employee Hiring, a single electronic docket communicated over a network is used. The method is networked for use by a business entity having multiple units. The hiring needs of one or more units is correlated with resumes from job hunters; potential candidates are selected and a single electronic docket is set up for each selected job candidate. The potential candidate is able to access all required job application forms over the network. However, multiple interviews with all of the hiring managers must be conducted.

A system for Human Capital Management uses the internet or an intranet system for all transactions and communications relating to human resource acquisition and employment. Job requests use standardized skill assessments and standardized profiles comprising organized skills and content attributes in place of resumes. Skill libraries can be set up. A qualitative and quantitative match is made between job and candidate. The method comprises the steps of generating at least one individual valuation profile, establishing minimum valuation requirements, generating filtering parameters, matching individual valuation profiles to minimum valuation requirements and aggregating individual valuation profiles having at least the minimum valuation requirements.

A career management system, method and computer program product discloses both a computerized method for managing a client's search for a job candidate as well as a computerized method and system for a person seeking a job to organize and manage the job search.

The problem with many of the screening methods used heretofore is that intangible qualities of likely candidates, such as demeanor, personality, and the ability to get along with specific employees within a department can only be determined during the interview process. With the above-listed methods, hiring managers and busy executives merely have access to resumes and written notes based on the perceptions of others. If an outside recruiting firm is employed, H.R. personnel also have to depend on the perception of the outside recruiters to learn about these intangible qualities. Ultimately, the last stage of the hiring process requires that the people responsible for the final hiring decision must have a live interview with a number of qualified job candidates. This is costly and problematic both in time spent by all hiring staff as well as the difficulty of scheduling interviews with busy upper level managers and executives, especially those who travel frequently. Job applicants may also have to travel to be interviewed, thereby adding the cost of travel and lodging to the hiring budgets. One other problem associated with traditional methods of screening potential job applicants is that the process can be lengthy, sometimes taking several months. At the final decision time, selecting a candidate to come back for a final interview and collaborating among managers as to the hiring decision has to be based upon the managers' memories of the interview and written notes.

### SUMMARY OF THE INVENTION

The system and method allow the hiring staff of an organization to view a secured web site and, at that one site, have access to essentially all of the tools used to screen likely job candidates. One of the most important tools available is a video recorded interview with a pre-qualified candidate based upon the specific requirements of the position. The video recording of the live interview in combination with resumes, background checks, references, skills and personality testing results are accessible at one web site that can be accessed world wide. The time consuming and costly practice of having each of the multiple hiring managers and Human Resource personnel involved in the hiring procedure interview multiple potential candidates is greatly reduced. H.R. staff and hiring managers are able to consider the personality and demeanor of a candidate before inviting the candidate to an in-personal interview. The recruiter, either an outside recruiting firm or a company's in-house recruiter, using the system and method of this invention, can provide one comprehensive website having substantially all of the screening components necessary to select a candidate for one or more specific job openings. Other necessary screening documents, such as resumes, reference checks and any required test results, in combination with a video of an interview, are organized in one easily accessible location. Beneficially, a decision maker can watch an in-person interview previously conducted with a qualified candidate as the decision maker accesses substantially all of the other essential screening components because these screening components are captured on one web site that is available world wide. Importantly, the video recording can be repeatedly accessed so that memories of a selected candidate can be reinforced at final decision time. The process of screening and hiring personnel is thereby facilitated.

In one embodiment of a web-based system for screening job candidates, a website comprises screening components for one or more specific job openings. Each job opening has specific parameters designated by a job description as determined by a user company or recruiter working with the company. The screening components begin with a list of one or more qualified job candidates who are pre-qualified according to the parameters designated for a specific job opening. The screening components beneficially include a video interview in combination with a resume for each listed job candidate, and test results, if any, for each listed job candidate. Preferably, the video interview comprises interview questions tailor-made according to the specific parameters of the job opening. The screening components further comprise a group of screening components selected from reference checks, background checks, credit checks, personality tests, skills tests, and drug tests for each listed job candidate. With the system and method of this invention, an authorized user can access one website and be able to view essentially all of the critical components necessary to screen a potential job candidate including a video recorded interview.

In one aspect of the invention, the system comprises a means for limiting accessibility to authorized users. The website preferably comprises a log-in screen, as well as a welcome screen for the logged-in user and links to one or more web pages, each web page comprising screening components for one specific job opening. In one embodiment, the log-in screen requires an I.D. code or some other form of identification which authorizes a user to proceed to the welcome screen. The means for limiting accessibility to authorized users can comprises a first set of filters for limiting access to the web site to users having an I.D. code. The system further comprises a second set of filters to limit access to specific web pages by an organizational hierarchy level of the authorized user.

In another aspect of this invention, the website is stored on data storing hardware of a remote dedicated server. The remote dedicated server is connected to a high security internet or intranet service provider that provides access to the website only the users having the authorized I.D. code or some other known means of identification. A networked communications system can be adapted to access the Internet.

A preferred method for screening job candidates for a specific job opening comprises prescreening job candidates according to parameters designated for the specific job opening. Preferably the parameters are designated according to a job description supplied by an authorized user. As part of the screening of the job candidate, the recruiter video records a live interview with a pre-screened job candidate using interview questions established according to the designated parameters. Screening components are administered as required for a specific job opening. Administering the screening components may require additional screening steps for qualifying job candidates including reference checking, background checking including both educational and employment histories, credit checking, personality testing, skills testing, and drug testing.

At some point in the method, either before or after the screening components are administered, a web page is designed having essentially all of the screening components for the specific job opening. As job candidates are pre-qualified for a position, the screening components for that job candidate are listed on the web page. The results of the background checking, credit checking, personality testing, skills testing, and drug testing for each candidate are posted on the web site preferably by hyperlinking the results to the web page where the job candidate is listed. Specifically the method of this invention can comprise the steps of hyperlinking the resume of job candidates to the web page, hyperlinking the video interview recorded for each listed job candidate to the web page and hyperlinking test results, if any, for each listed job candidate to the web page.

Access to the web site is limited to authorized users. An authorized user logs on the web site using a security code and is then directed to a welcome page having a listing of one or more jobs presently opened at the user's organization. The authorized user selects a job opening for screening purposes and accesses a web page designed specifically for that job opening. Access to the hyperlinks to the various screening components may be limited according to the position of the user within the hierarchy of the company. Limiting access to specific web pages on the web site can comprise using one or more filters to allow access based on organizational hierarchy level of the client company. Once the web page is selected, an authorized user is able to view essentially all of the critical components necessary to screen a potential job candidate including a video recorded interview.

### BRIEF DESCRIPTION OF THE DRAWINGS

FIG. 1 is a schematic of the web-based system of this invention.

FIG. 2 is an illustration of one preferred web page.

FIG. 3 is an illustration of one preferred web page.

FIG. 4 is an illustration of one preferred web page.

FIG. 5 is a flow diagram of a preferred method of the present invention.

### DETAILED DESCRIPTION OF THE PREFERRED EMBODIMENT

The preferred embodiments of the present invention provide a web-based system and method for screening job candidates. The system and method allow the hiring staff of an organization to view a secured web site and have access to the essential screening components required to select a job candidate, including a video interview of a pre-qualified candidate. The video recorded interview allows human resource staff and hiring managers to consider the personality and demeanor of a candidate before inviting the candidate to personal interviews. The recruiter, either an outside recruiting firm or a company's in-house recruiter, using the system and method of this invention, can provide one comprehensive website, viewable world wide if necessary, that has the screening components essential for filling one or more specific job openings. Essential screening components include but are not limited to: a list of one or more pre-qualified job candidates, a video interview of the listed job candidates in combination with a resume for each listed job candidate, test results, if any, for each listed job candidate, and references for each listed job candidate. The necessary screening documents, in combination with a video of an interview, are organized in one easily accessible location. Beneficially, a decision maker can access substantially all of the essential screening components, including a live interview with the candidate, because these screening components are captured on one web site, thereby facilitating the hiring process.

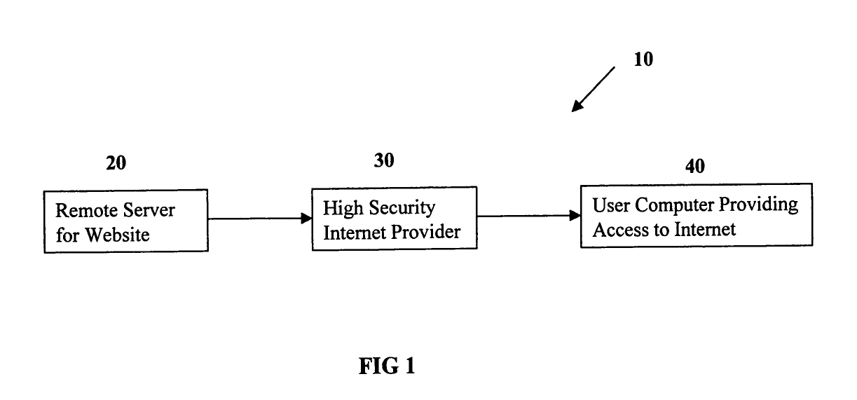

FIGS. 1 through 4 illustrate one embodiment of the system of this invention. The system comprises a web site dedicated to screening candidates for job openings for a company or other organization. When a user accesses the web site, the user is required to login using a means for limiting accessibility as used within a security authorization system. Software is programmed to initially authenticate the user by requesting and receiving authorization information such as client identification, passwords, or other means of identification as provided by the client company. An alternative method of securing access to the website, or means for authenticating the user, is sophisticated bodyscan coding. Bodyscan coding uses the client's eye, finger or hand prints to identify the service provider as an authorized user. A service provider's computer can be adapted to scan the body part and transmit the information to the website host computer which matches the scan to a list of authorized users. Other methods of identifying the user can also be used to limit access. One preferred means for limits accessibility to users having an authorized I.D. code.

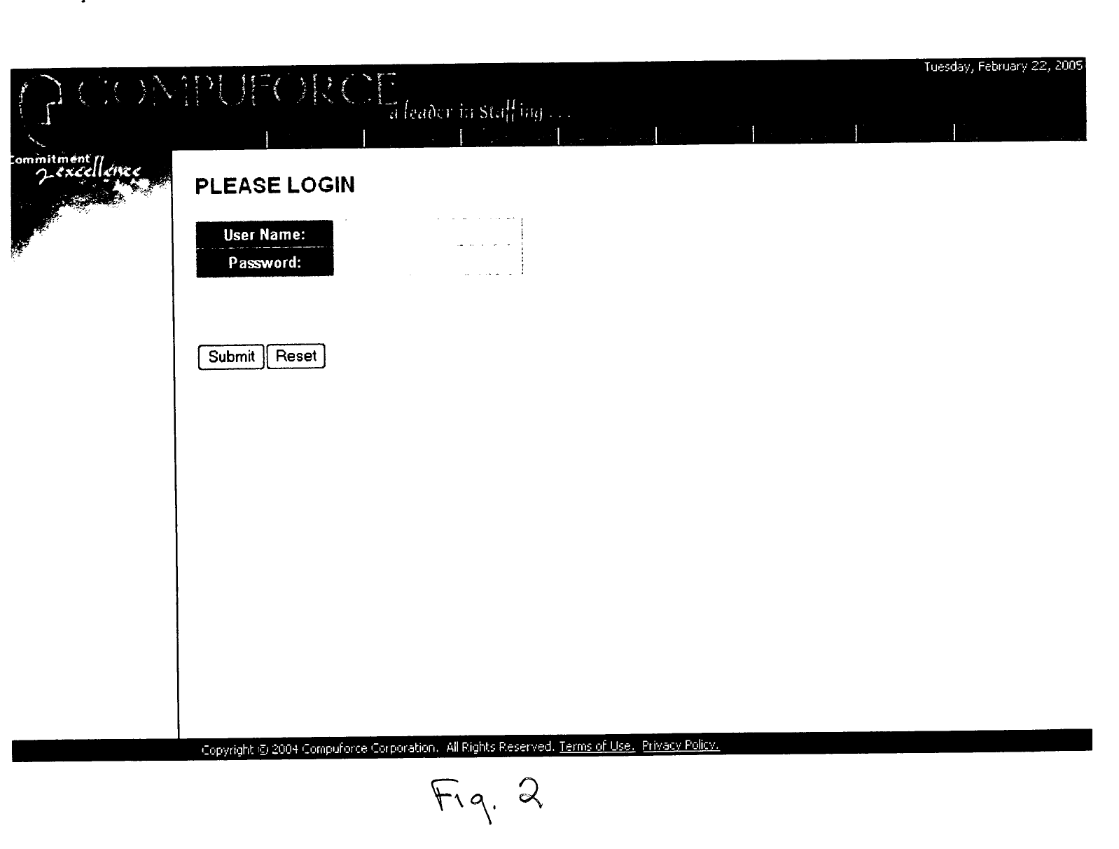

The web based system comprises a remote dedicated server 20 comprising hardware for storing data for the website; and a high security internet or intranet service provider (ISP) 30 connected to the dedicated remote server 20 for providing access to the website by means of the computers 40 of authorized users. A networked communications system can be adapted to access the Internet. The web site can reside on the remote server or a server of the ISP. As seen in FIG. 2, the first screen accessed is a home page requiring security or authorizing information. While a small company may limit access to the web site to one hiring manager or president, large companies often have layers of personnel who are involved in the hiring process, from human resource personnel to multiple hiring managers to reviewers who merely screen likely candidates. In one embodiment of the system of this invention, one or more filters are used which allows for limiting viewing privileges to specific layers of personnel. In one embodiment, a first set of filters allows access by authorized code and a second set of filters allows access to specific web pages based on predetermined parameters of hierarchy in the organization.

Large companies may have multiple personnel who are involved in staffing for job openings. Hiring personnel can include H.R. employees who communicate with the recruiter and screen potential job applicants. The H.R. employees can include various levels of staff from an H.R. manager down to staff reviewers who merely screen the applicants based on pre-determined qualifications. For example, the decision-making executive or H.R. manager can be allowed complete privileges to view all screening information. One or more hiring managers who play a part in the hiring procedure can have more limited privileges and those who job is to merely screen likely candidates have the least access to view the multiple screening components. Alternatively, any authorized user can view all screening components.

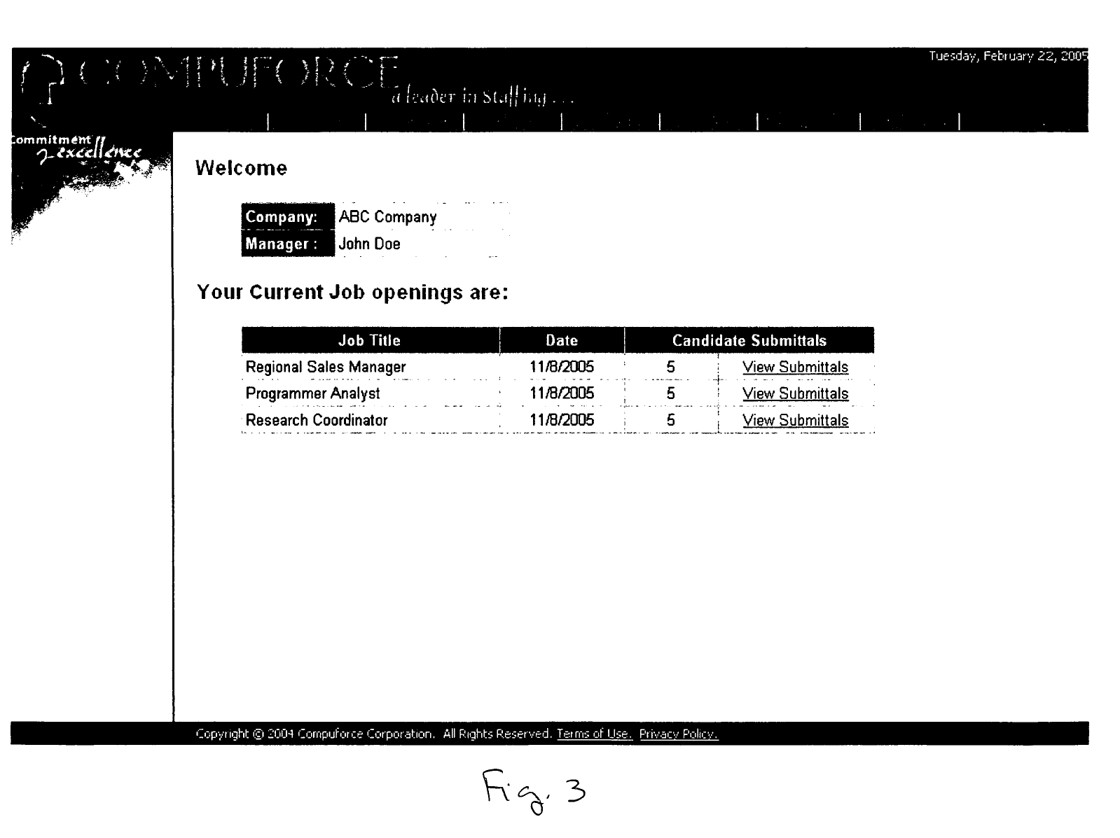

Once an authorized user logs in, the user has gained access to a welcome screen specifically designed for the user. As shown in FIG. 3, the welcome screen or page lists the company name and the authorized user's name. The welcome screen will also have a list of the one or more jobs currently opened at the user's organization that the user has authority to view and links to one or more subsequent page listing job candidates submitted for each job opening and their profiles. The job candidates listed are pre-qualified by the recruiter. Each specific job opening comprises predetermined parameters designated within a job description supplied by the organization or elicited by the recruiter during dialog with H.R.

Pre-qualification is an important aspect of the system and method of this invention because one step of the pre-qualification of likely candidates is making a video interview with the recruiter based upon the organization's parameters for qualification. It is well known in the field of personnel hiring that a person's demeanor and personality traits such as enthusiasm, ability to communicate, maturity etc. often cannot be quantified in a resume. How a candidate conducts herself during the interview is often the deciding factor in the hiring procedure. The video interview can be structured according to the parameters of the job opening as set forth by the organization. Preferably, the video interview comprises interview questions that are tailor-made for the job opening according to these pre-determined parameters.

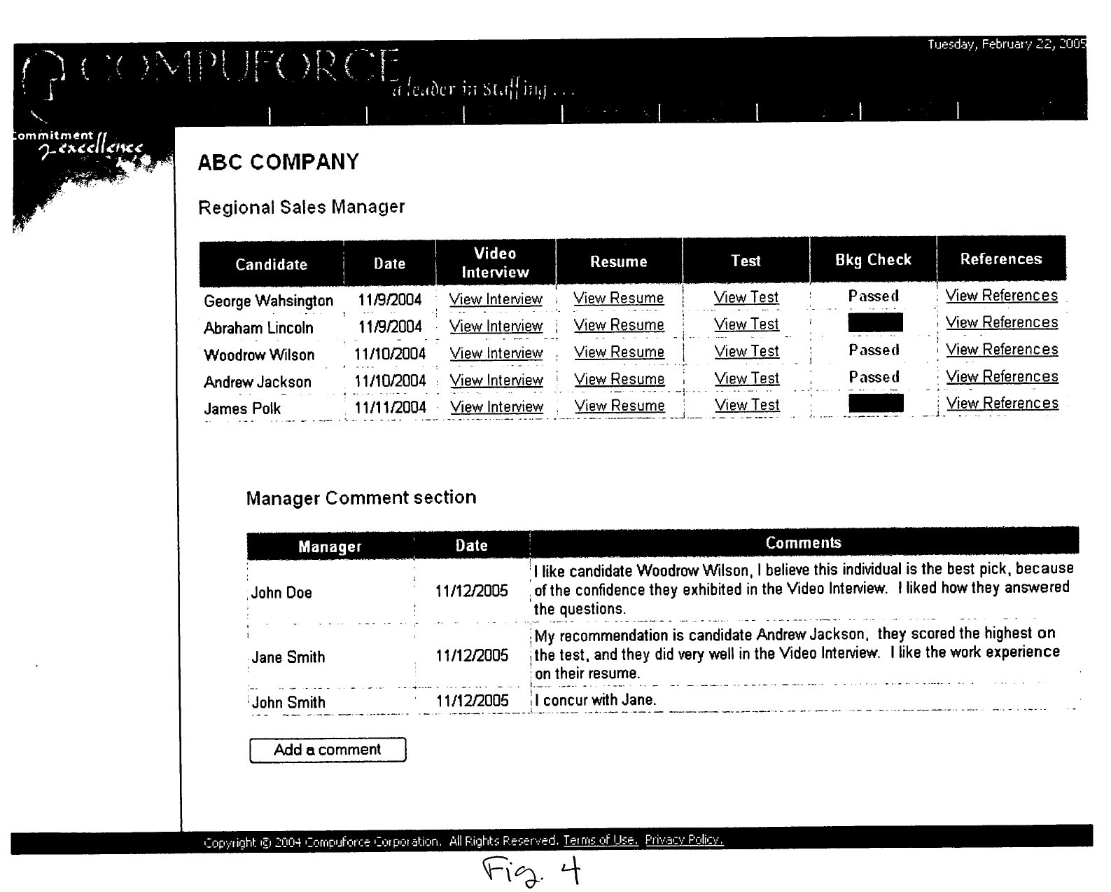

As seen in FIG. 4, the web page listing the available candidates comprises the date the candidate was listed and links to the various screening components that will define a relatively complete profile of the candidates. The screening components comprise a group of screening components that are used to determine the best applicant for a position. These components include a video interview with the job candidate in combination with more typical screening tools such as a resume, and test results, if any, and references for each listed job candidate. The screening components can further comprise background checks, credit checks, personality tests, skills tests, and drug tests. The benefit of this invention is that all of these screening tools are accessible from one web site. This combination of a video interview with other screening tools facilitates candidate selection saving time for all involved.

As discussed earlier, large companies may have multiple personnel involved in the hiring process. The hiring decision can be made by a pool of employees in the company's hierarchy including H.R. people, who also do the initial screening of the pro-offered candidates, security managers, one or more levels of hiring managers and supervisors within a department of the company or from other departments as well as several executive-level officers of the company. Prior to this invention, live interviews had to be set for each employee involved in the hiring decision. Advantageously, this invention allows the decisions makers to easily access and view the critical components of the screening process, including a video interview with the candidate, world-wide, from any computer with access to the internet.

As seen on FIG. 4, the web page also comprises a manager comment section. After viewing the screening components for a listed job candidate, the hiring personnel can make comments regarding the qualifications of the candidates and select one or more candidates for further interviews. In some cases where in-person interviews are not possible for time or cost reasons, a manager can even make a hiring decision based on the video interview and other screening tools. Other authorized users can view the comments so that decisions regarding the best candidates can be made. The hiring process is streamlined so that both the time and expense involved in filling a job opening are significantly reduced.

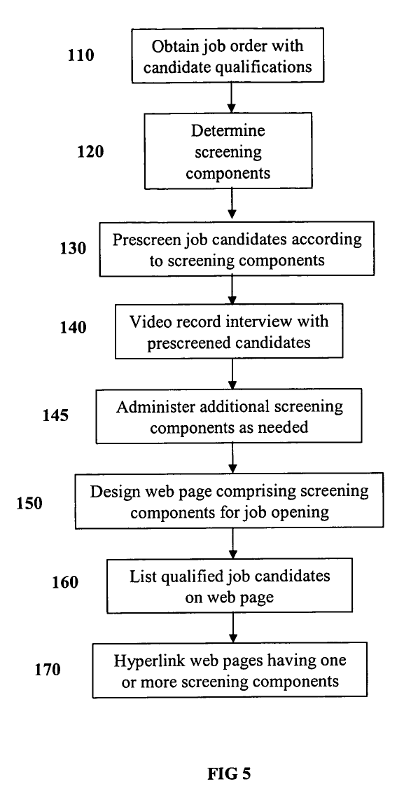

While practicing the method of this invention, a recruiter facilitates the work of hiring personnel by performing the preliminary steps of prescreening and interviewing potential job candidates. Beneficially, the prescreening efforts of the recruiter are captured on a single web site for easy access by any authorized user. The hiring process is streamlined thereby cutting costs and time expended by all involved. Referring to FIG. 5, during the method for screening job candidates for a specific job opening, a recruiter, either an outside placement firm or an in-house recruiter, first obtains a job order from a client company or organization. The recruiter elicits the qualifications of competent candidates from the client as well as the screening tools or components that the client deems necessary to measure skills, background and qualifications of the candidates.

Job candidates are prescreened according to the parameters and screening components designated for the specific job opening. The parameters are designated according to a job description as supplied an authorized user of the client company. Alternatively, the recruiter elicits information from the client company and defines the parameters of the job description. The recruiter also defines the desired screening components according to the requirements of the client company. The recruiter administers the screening components to qualify potential job candidates as part of the pre-screening process. In one aspect, pre-screening can include the step of pre-interviewing potential job candidates by telephone. Additional screening components are selected from a group of screening components including reference checking of likely job candidates, background checking, credit checking, personality testing, skills testing, and drug testing. One of the most advantageous screening components, used in combination with those listed above, is a live interview with the job candidate to determine intangible personality characteristics and demeanor. This live interview with the recruiter is video recorded. Questions asked during the interview are established either based on the parameters set forth for the job order, or in some cases specifically designed by the client company.

As data is gathered regarding the job opening and screening of potential job candidates, a recruitment web site is set up and designed for the user company having job openings specific for that company. At some point in the method, either before or after the screening components are administered, one or more web pages are designed for the web site, each page having essentially all of the screening components for one specific job opening. As job candidates are pre-qualified for a position, the screening components for that job candidate are posted on the web page designated for that position. Access to the recruitment web site is available to authorized users either through a high security networked communications system adapted to access the Internet or an internal intranet computer system. Authorized users are required to login to the recruitment web site using a means for limiting accessibility as used within a security authorization system. Filters are used to limit access to users having an authorized I.D., either a password or scan such as described above. Access to specific web pages or hyperlinks on the web site can also be accomplished by using one or more filters to allow access based on organizational hierarchy level of the client company. For example, sensitive security data or criminal background checks may not be available to all authorized users. Filters can prevent access to unauthorized I.D. codes.

After logging on, the authorized user has access to a web page for a specific job opening. The web page has substantially all of the essential screening components necessary for filling that position. Prescreened job candidates are listed on the web page along with the date of listing and hyperlinks to the screening components. In some cases, the results of the screening are listed. Referring to FIGS. 4 and 5, the method of this invention comprises hyperlinking the resume of job candidates listed on the web page and hyperlinking the video interview recorded for the listed job candidate to the web page in combination with the resume and other screening components.

The recruiter video recorded a live interview with a prescreened job candidate using interview questions established according to the parameters designated for the job opening. Along with placing the screening components on the web page, the video interview and resume of one or more listed qualified job candidates can also be emailed to authorized users. In addition to the resume and video interview, the web site also hyperlinks test results, if any, for each listed job candidate, as well as references for each listed job candidate. Depending on the requirements of the client company, other screening components can be administered and the results hyperlinked to the web page.

The results of the screening, including background checking, credit checking, personality testing, skills testing, and drug testing for each candidate are posted on the web page by hyperlinks found on the job opening web page. The client company's hierarchy of employees having authority to view the web page includes H.R. people, security managers, one or more levels of hiring managers and supervisors within a department of the company or from other departments as well as several executive-level officers of the company. Access to the hyperlinks for the various screening components may be limited according to the position of the user within the hierarchy of the company. Limiting access to specific web pages or hyperlinks on the web site can comprise using one or more filters to allow access based on organizational hierarchy level of the client company. In one preferred method, accessibility to the web page is limited to users according to their authorized I.D. code

A manager's comment section is also provided on the web page for a job opening. After viewing the screening components for a listed job candidate, the hiring personnel can make comments regarding the qualifications of the candidates and select one or more candidates for further interviews. In some cases where in-person interviews are not possible for time or cost reasons, a manager can even make a hiring decision based on the video interview and other screening tools. Beneficially, a decision maker can access substantially all of the essential screening components, including viewing a live interview with the candidate, because these screening components are captured on one web page, thereby facilitating the hiring process. The hiring process is streamlined so that both the time and expense involved in filling a job opening are significantly reduced.

Although described in terms of the preferred embodiments shown in the figures, those skilled in the art who have the benefit of this disclosure will recognize that changes can be made to the individual component parts thereof which do not change the manner in which those components function to achieve their intended result. For example, altering the individual screening components which comprise the screening process is a change intended to fall within the scope of the following non-limiting claims.

I claim:

1. A web-based system for screening job candidates comprising:
a website comprising screening components for one or more specific job openings, the screening components comprising:
a list of one or more job candidates, the job candidates pre-qualified for one or the specific job openings;
a video interview for the listed job candidate, the video interview in combination with a resume for each listed job candidate, and test results, if any, for each listed job candidate;
a means for limiting accessibility to an authorized user;
a remote dedicated server comprising hardware for storing data for the website; and
a high security internet or intranet service provider connected to the dedicated remote server for providing access to the website by the authorized users.

2. The system of claim 1 wherein the screening components further comprise references for each listed job candidate.

3. The system of claim 1 wherein the screening components further comprise a group of screening components selected from background checks, credit checks, personality tests, skills tests, and drug tests.

4. The system of claim 1 wherein the website comprises a log-in screen, a welcome screen for the logged-in user and links to one or more web pages, each web page comprising screening components for one specific job opening.

5. The system of claim 1 wherein each specific job opening comprises predetermined parameters designated within a job description supplied by an authorized user.

6. The system of claim 5 wherein the each job candidate listed is pre-qualified according to the predetermined parameters for each specific job opening.

7. The system of claim 5 wherein the video interview comprises interview questions that are tailor-made for the job opening according to the pre-determined parameters.

8. The system of claim 1 wherein the means for limiting accessibility to authorized users comprises a first set of filters for limiting access to the web site.

9. The system of claim 8 further comprising a second set of filters to limit access to specific web pages by an organizational hierarchy level of the authorized user.

10. A web-based system for screening job candidates comprising:
a website comprising screening components for one or more specific job openings, each job opening comprising specific parameters designated by a job description, the screening components comprising:
a list of qualified job candidates, the job candidates qualified according to the parameters of a specific job opening, a video interview in combination with a resume for each listed job candidate, and test results, if any, for each listed job candidate, the video interview comprising interview questions tailor-made according to the specific parameters of the job opening;
one or more filters for limiting accessibility to authorized users;
a remote dedicated server comprising hardware for storing data for the website; and
a high security internet or intranet service provider connected to the remote server for providing access to the website by the authorized.

11. The system of claim 10 wherein the screening components further comprise a group of screening components selected from references checks, background checks, credit checks, personality tests, skills tests, and drug tests for each listed job candidate.

12. The system of claim 10 further comprising a second set of filters for limiting access to specific web pages on the web site based on the organizational hierarchy level of an authorized user.

13. The system of claim 10 wherein each specific job opening comprises predetermined parameters and the filters allow access to specific web pages based on the predetermined parameters.

14. The system of claim 10 wherein the website further comprises a home page for signing on to gain access to web pages based on an authorized I.D. code.

15. The system of claim 10 wherein the website further comprises a manager comment section.

16. A method for screening job candidates for a specific job opening comprising:
(a) pre-screening job candidates according to parameters designated for the specific job opening;
(b) video recording an interview with prescreened job candidate using interview questions established according to the parameters designated for the job opening;
(c) administering screening components according to the screening components required for a specific job opening;
(c) designing a web page comprising screening components for the specific job opening;
(d) listing on the web page job candidates qualified for the job opening by prescreening according to step (a);
(e) hyperlinking the resume of job candidates listed in step (d) to the web page;
(f) hyperlinking the video interview recorded in step (d) for each listed job candidate to the web page;
(i) hyperlinking test results, if any, for each listed job candidate, and
(j limiting accessibility to the web page to authorized users.

17. The method of claim 16 wherein parameters are designated according to a job description supplied by an authorized user.

18. The method of claim 16 further comprising the step of emailing the video and resume of one or more listed qualified job candidates to authorized users.

19. The method of claim 16 wherein the step of pre-screening comprises interviewing potential job candidates by telephone.

20. The method of claim 16 wherein the step of limiting access to specific web pages on the web site comprises using one or more filters to allow access based on organizational hierarchy level of the authorized user.

21. The method of claim 16 further comprises performing additional screening steps for qualifying job candidates, the screening steps selected from a group of screening steps comprising reference checking, background checking, credit checking, personality testing, skills testing, and drug testing.

22. The method of claim 21 wherein the results of the background checking, credit checking, personality testing, skills testing, and drug testing for each candidate are hyperlinked to the web page.

23. The method of claim 16 further comprising providing a manager comment section on the web page.

24. A method for screening job candidates for a specific job opening comprising:
(a) prescreening job candidates according to designated parameters;
(b) video recording an interview with the one or more candidates qualified by prescreening using interview questions based on the designated parameters;
(c) designing a web page comprising screening components for the job opening;
(d) listing qualified job candidates on the web page;
(e) posting the one or more screening components on to the web page;
(i); hyperlinking the video interview recorded in step (b) for each listed job candidate to the web page; and
(j) limiting accessibility to the web page to users having an authorized I.D. code.

25. The method of claim 24 wherein the step of designing a web page with screening components further comprises:
hyperlinking the resume of job candidates listed in step (d) to the web page;
hyperlinking test results, if any, for each listed job candidate, and
hyperlinking references for each listed job candidate to the web page.

26. The method of claim 24 further comprising administering screening components according to the screening components required for a specific job opening.

27. The method of claim 26 wherein the results from the screening components administered are hyper-linked to buttons for the screening components posted on the web page.

28. The method of claim 24 wherein job candidates are prescreened by telephone interviews.

29. The method of claim 24 wherein the step of limiting access to specific web pages on the web site comprises using one or more filters to allow access to the authorized user having an I.D. code.
